(19) United States
(12) Patent Application Publication
(10) Pub. No.: US 2018/0149128 A1
(43) Pub. Date: May 31, 2018

(54) METHOD FOR PRODUCING A NOZZLE BODY FOR A FLUID INJECTION VALVE, AND FLUID INJECTION VALVE

(71) Applicant: CONTINENTAL AUTOMOTIVE GMBH, Hannover (DE)

(72) Inventors: Dejan Jovovic, Regensburg (DE); Hong Zhang, Tegernheim (DE)

(73) Assignee: CONTINENTAL AUTOMOTIVE GMBH, Hannover (DE)

(21) Appl. No.: 15/882,499

(22) Filed: Jan. 29, 2018

Related U.S. Application Data
(63) Continuation of application No. PCT/EP2016/065131, filed on Jun. 29, 2016.

(30) Foreign Application Priority Data
Jul. 29, 2015 (DE) 10 2015 214 306

(51) Int. Cl. F02M 61/10

(52) U.S. Cl. CPC F02M 61/10

(57) ABSTRACT

A method for producing a nozzle body for a fluid injection valve includes supplying a nozzle body blank having a nozzle body tip and introducing a nozzle body recess into the nozzle body blank, starting from a first axial end, and thereby forming a wall. The method furthermore includes supplying geometry data of at least one injection hole to be provided, with an inner opening and an outer opening, and determining a height of a blind hole step of a blind hole to be formed, in a manner dependent on a predefined fluid penetration. The method furthermore includes adapting a part of the shape of an inner surface of the wall and thereby forming the blind hole with the blind hole step of the determined height and introducing the at least one injection hole with the supplied geometry data, so that the at least one injection hole penetrates the wall.

### CROSS REFERENCE TO RELATED APPLICATIONS

This application claims the benefit of International application No. PCT/EP2016/065131, filed Jun. 29, 2016, which claims priority to German patent application No. 10 2015 214 306.6, filed Jul. 29, 2015, each of which is hereby incorporated by reference herein in its entirety.

### FIELD OF INVENTION

The invention relates to a method for producing a nozzle body for a fluid injection valve and to a fluid injection valve for a motor vehicle, which are suitable for metering in fluid, in particular fuel.

### BACKGROUND

Internal combustion engines are often designed to produce high torques, which require large injection quantities. On the other hand, legal regulations relating to the permissible pollutant emissions of internal combustion engines installed in motor vehicles require various measures for lowering pollutant emissions to be taken. A starting point here is to lower the pollutant emissions produced by the internal combustion engine.

The reduction of pollutant emissions from internal combustion engines and precise metering of the fluid to be metered in are a major challenge in the design of fluid injectors. In this context, fluid injection valves are often constructed with a plurality of injection holes in order to produce a fluid spray and feed it into a combustion chamber of an internal combustion engine. One important parameter here is fluid penetration of the fluid spray within the combustion chamber in order to control a combustion process in the internal combustion engine and the emission of pollutants, among other considerations.

Fluid penetration is ensured by distribution of the fluid spray after a predefined delay, starting from a starting time of injection into the combustion chamber. For example, fluid penetration is measured along an associated axis of the respective injection hole and represents a distance, starting from an outer opening of the injection hole, which faces the combustion chamber of the internal combustion engine, up to a predefined retardation point, for example.

In general, it is a matter of concern to keep penetration of the fluid spray down in order, for example, to prevent fluid spray from impinging on internal walls of the combustion chamber. Depending on the application and the geometry of the respective combustion chamber, fluid injection valves must be precisely positioned to comply with corresponding fluid penetration specifications.

### SUMMARY

One object underlying the invention is to provide a method for producing a nozzle body for a fluid injection valve, a device for a fluid injection valve and a fluid injection valve for a motor vehicle which are suitable for achieving a desired fluid penetration and keeping down pollutant emissions in internal combustion engines in a simple manner.

A method for producing a nozzle body for a fluid injection valve is indicated. The method includes supplying a nozzle body blank, which has a longitudinal axis and, in relation to the longitudinal axis, a first axial end and a second axial end. The second axial end has a nozzle body tip.

The method furthermore includes introducing a nozzle body recess into the nozzle body blank, starting from the first axial end, and thereby forming a wall between the nozzle body recess and an outer surface of the nozzle body blank. Moreover, the method includes supplying geometry data of at least one injection hole to be provided, which is intended to penetrate the wall as far as the outside, starting from the nozzle body recess, with an inner opening, which faces the nozzle body recess, and an outer opening, which faces the outer surface.

The method furthermore includes determining a height of a blind hole step of a blind hole to be formed, in a manner which is dependent on a predefined fluid penetration, starting from the outer opening of the respective injection hole, into the environment of the nozzle body. In other words, it is, in particular, the shape of a fluid spray cone discharged by means of the injection hole which is specified, and the height of the blind hole step is determined in a manner dependent on the shape of the spray cone. The “environment” of the nozzle body is, in particular, the space which adjoins the outer surface of the wall and which is away from the nozzle body recess.

Moreover, the method includes adapting a part of the shape of an inner surface of the wall and thereby forming the blind hole with the blind hole step of the determined height in relation to the longitudinal axis in a region of the second axial end of the nozzle body blank.

Moreover, the method includes introducing the at least one injection hole with the supplied geometry data in a region of the blind hole between a blind hole step end facing the second axial end and the nozzle body tip in such a way that the at least one injection hole penetrates the wall.

By means of the method described, it is possible in a simple manner to obtain a nozzle body for a fluid injection valve which allows a desired fluid penetration and thereby contributes to keeping down pollutant emissions in an internal combustion engine. By varying the height of the blind hole step, it is advantageously possible to selectively influence fluid penetration. Fluid penetration represents, for example, a spreading out of a fluid spray in the direction of flow at a downstream end of the respective injection hole, based on a flowing fluid which flows from the first axial end in the direction of the second axial end during operation.

In a production method of the nozzle body, an inner and/or outer contour of the nozzle body is first of all produced for example, starting from the nozzle body blank. As an alternative, the nozzle body blank already has a pre-produced inner and/or outer contour of the nozzle body. Here, the blind hole step to be formed in the associated blind hole has not yet been introduced as desired.

Before introduction into the supplied and possibly pre-produced nozzle body blank, the height of the blind hole step is determined in a manner dependent on a predefined fluid penetration for the nozzle body or an associated fluid injection valve and, after this, a blind hole contour of the blind hole is formed, e.g., by means of boring or milling. The introduction of the blind hole contour with the determined height of the blind hole step on an inner side of the nozzle body blank is performed, for example, before the introduction of the at least one injection hole, which is likewise bored and/or milled into the nozzle body to be produced, for example. The term “blind hole contour” is used to refer to at least part of the shape of an inner surface of the wall.

In this way, it is possible to control fluid penetration without promoting soot formation on the nozzle body tip, for example. The formation of the blind hole step of the determined height may affect the fluid penetration associated with all the injection holes to be introduced since, for example, the blind hole step is arranged ahead of the inner opening of the respective injection hole in relation to a flow direction of a flowing fluid. Individual adaptation of the fluid penetration of a respective injection hole may be achieved, for example, by adaptation of the diameter and/or a conical formation of the injection hole.

In respect of advantageous symmetrical formation of the nozzle body and of arrangement in a fluid injection valve, the blind hole step is formed substantially parallel to the longitudinal axis of the nozzle body, for example. In another embodiment, however, it is also possible for the blind hole step to have a predefined slope relative to the longitudinal axis and thereby to influence fluid penetration. In such a case, the height of the blind hole step then relates, for example, to a projection of the geometrical length thereof parallel to the longitudinal axis. The term “blind hole step” is used to refer to a blind hole section in which the inner surface of the wall is cylindrical.

By means of the method described, fluid penetration is selectively controlled by geometry data that are formed in a controlled manner substantially within the nozzle body. In the context of the description below, the geometry data may also be shortened to the term “geometry”. Thus, for example, it is not necessary to adapt a geometry of the outer opening of the respective injection hole in order to influence fluid penetration by, for example, forming a stepped hole at the downstream end of the injection hole. In the case of a stepped hole of this kind, there is the risk of increased deposits of carbon due to residual fuel on the surface of the stepped hole and the nozzle tip. This leads to the formation of honeycomb-shaped carbon structures, which may both disadvantageously affect the operation of the nozzle body or of an associated fluid injection valve and lead to increased pollutant emissions.

In one embodiment of the method, the injection hole is shaped in such a way that it penetrates the wall without a step from the nozzle body recess to the outer surface of the nozzle body. In particular, the surface of the injection hole is free from steps and from bends from the inner surface to the outer surface of the nozzle body. Thus, the risk of soot formation in the region of the injection hole is particularly low.

By means of the method described, it is thus possible to obtain a nozzle body and a fluid injection valve which counteract increased deposition of carbon and contribute to keeping down pollutant emissions in an associated internal combustion engine.

According to one embodiment of the method, a length and a diameter are determined as the geometry of the at least one injection hole in a manner dependent on the predefined fluid penetration.

In this way, the method is extended in such a way that not only the height of the blind hole step but also a length and a diameter of at least one cylindrical injection hole are determined in a manner dependent on the fluid penetration. In this way, a desired fluid penetration may be selectively achieved and optimized according to application and combustion chamber by the formation and interaction of a plurality of geometrical parameters. Inter alia, it is possible in this way to adapt a fluid penetration for each injection hole individually and/or to meet specifications for fluid preparation that cannot be achieved by means of the geometry of the blind hole step alone.

According to one embodiment of the first aspect, the height of the blind hole step is determined in a manner dependent on the determined length and on the determined diameter of the at least one injection hole.

Such a method takes into account the fact that fluid penetration is dependent on interaction between the length and diameter of the respective injection hole and the height of the blind hole step. These parameters may be matched to one another in mutual dependence in such a way that a desired fluid penetration is achieved. For example, the fluid penetration requirements may be achieved by means of the formation of the blind hole step. If appropriate, however, a value for the height of the blind hole step which may be achieved only with difficulty in the context of a production process is determined. It is then useful, for example, to additionally determine a value for the height of the blind hole step in a manner dependent on the geometry of the injection hole in order in this way to achieve the desired fluid penetration and allow a simple production process.

In one embodiment of the method, adaptation of the part of the shape of the inner surface of the wall and consequent formation of the blind hole with the blind hole step of the determined height are accomplished by reducing the wall thickness of a part of the wall between the nozzle body recess and the outer surface. In particular, the wall thickness is reduced by means of a material-removing method, such as boring or milling. In this way, it is possible to produce nozzle bodies with different spray cones from identical nozzle body blanks without the need for modifications to the outer surface of the nozzle body—e.g. in the form of stepped holes. In this way, production may be carried out in a particularly economical manner.

According to another embodiment of the method, a length and a diameter are specified as geometry data of the at least one injection hole in order to achieve the predefined fluid penetration. Here, the invention exploits the idea that the fluid penetration may be largely determined from the ratio of the length to the diameter of the injection hole.

In this embodiment, it is expedient if the height of the blind hole step is chosen in such a way that, when the injection hole is formed, the blind hole step reduces the wall thickness between the inner surface and the outer surface precisely to such an extent that, when the injection hole with the determined length and the outer opening in the outer surface is introduced, the inner opening is positioned in the inner surface. In this way, it is advantageously possible to use identical nozzle body blanks to produce nozzle bodies with unstepped injection holes of different lengths.

According to another embodiment, the method includes supplying a conical geometry of the at least one injection hole, wherein the geometry data includes a first and a second diameter. The method furthermore includes determining the first diameter and the second diameter of the at least one injection hole in a manner dependent on the predefined fluid penetration, wherein the first diameter is assigned to the inner opening and the second diameter is assigned to the outer opening.

A conical injection hole has a frustoconical configuration. This may have an advantageous effect on fluid penetration. Depending on the respective application and the respective combustion chamber of the associated internal combustion engine, a conical injection hole or a cylindrical injection hole may be advantageous for achieving the specifications for a desired fluid penetration.

For example, a value for the height of the blind hole step is determined which may be achieved only with difficulty in the context of a production process and in combination with a cylindrical injection hole. It may then be useful to provide a conical geometry of the injection hole and to determine the length and the first and second diameters of the at least one injection hole in a manner dependent on the desired fluid penetration.

Moreover, other geometries of the injection hole which are determined in a manner dependent on fluid penetration requirements and, in interaction with the blind hole step formed as specified, allow a desired fluid penetration are also possible.

According to another embodiment of the method, the first diameter and the second diameter of the at least one injection hole are additionally determined in a manner dependent on the height determined.

In this context, attention is drawn to the fact that the fluid penetration is dependent on an interaction between the length and the two diameters of the conical injection hole. It may also be dependent on the height of the blind hole step. These parameters may be matched to one another in mutual dependence in such a way that a desired fluid penetration is achieved. Thus, it is also possible for the height of the blind hole step to be determined in a manner dependent on the conical geometry of the injection hole since the dependence is mutual.

According to another embodiment of the method, adaptation of a part of the shape of the inner surface of the wall includes forming a seat region for a nozzle needle adjoining the blind hole step in the direction of the first axial end.

Such a method includes forming a seat region for a nozzle needle which, in a fluid injection valve, prevents a fluid flow in contact with the seat region in a closed position or otherwise allows said flow.

According to another embodiment of the method, adaptation of a part of the shape of the inner surface of the wall includes forming a guiding region for guiding a nozzle needle in the region of the first axial end in the direction of the second axial end.

This method step too allows a further refinement of the nozzle body for use in a fluid injection valve in order to enable controlled metering of fluid by means of the nozzle body and of the associated fluid injection valve. In the context of the method, adapting a part of the shape of the inner surface of the wall to form the seat region and/or the guiding region may take place temporally before or after, or simultaneously with, the adaptation of a part of the shape of the inner surface of the wall to form the blind hole.

A device for a fluid injection valve includes, for example, a nozzle body which is produced by one of the methods described above for producing the nozzle body, and a valve body, which is coupled to the nozzle body.

A device of this kind implements a possible intermediate stage between the production of the nozzle body and a fluid injection valve which includes an embodiment of the nozzle body. The above-described substantive properties and functions of the method for producing the nozzle body also apply to the device.

The nozzle body is coupled positively and/or nonpositively and/or materially to the valve body.

A device of this kind implements possible kinds of coupling of the nozzle body to the valve body in which the nozzle body produced as described is connected firmly to the valve body in a further method step, for example. As an alternative, the valve body may be formed integrally with the nozzle body.

For example, a valve body which is suitable for accepting further components of the fluid injection valve, for example, is also formed in the context of the method for producing a nozzle body. Thus, the nozzle body blank supplied in the method for producing a nozzle body also includes the valve body to be formed, and the nozzle body described essentially forms the tip of the valve body, for example.

According to a second aspect of the invention, a fluid injection valve for a motor vehicle is indicated. This may have a nozzle body or the device with the nozzle body. Moreover, it has a nozzle needle which is arranged at least partially in the nozzle body recess in such a way as to be axially movable in relation to the longitudinal axis and which is designed to prevent a fluid flow in interaction with a seat region in a closed position and otherwise to allow said flow.

A fluid injection valve of this kind has, in particular, the above-described properties of the device or nozzle body produced by one of the above-described methods.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

Illustrative embodiments of the invention are explained in greater detail below with reference to the schematic drawings. In the drawings:

FIG. 1 shows a flow diagram of a method for producing a nozzle body, and

FIG. 2 shows an illustrative embodiment of a nozzle body in a schematic longitudinal section.

### DETAILED DESCRIPTION

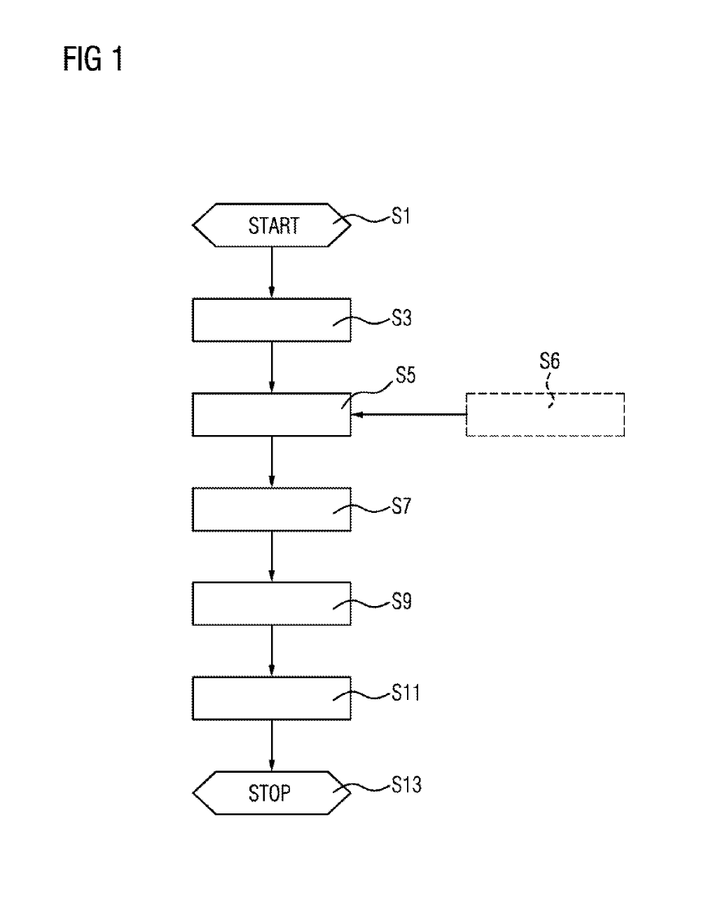

FIG. 1 shows an example of a flow diagram of a method for producing a nozzle body 1 for a fluid injection valve, which is started in a step S1 and in which a nozzle body blank is supplied, which has a longitudinal axis A as well as a first axial end 3 and a second axial end 5 with a nozzle body tip 20 in relation to the longitudinal axis A.

In a subsequent further step S3, a nozzle body recess 7 is introduced into the nozzle body blank, starting from the first axial end 3, and a wall 9 is thereby formed between the nozzle body recess 7 and an outer surface 11 of the nozzle body blank. The nozzle body recess 7 is formed in the nozzle body blank by boring and/or turning, for example.

In a further step S5, a geometry of at least one injection hole 17 to be provided is supplied, which is intended to penetrate the wall 9 as far as the outside, starting from the nozzle body recess 7, with an inner opening 18, which faces the nozzle body recess 7, and an outer opening 19, which faces the outer surface 11.

The geometry supplied includes a diameter and a length L and a diameter for a cylindrical injection hole 17 to be formed, for example. As an alternative, the supplied geometry includes a first diameter D1, a second diameter D2 and a length L of a conical injection hole 17 to be formed. If a plurality of injection holes 17 are provided for the nozzle body 1, optionally some of the injection holes 17 are cylindrical and some conical. Moreover, other geometries of the injection holes 17 are also possible. The supplied geometry data for each injection hole 17 preferably additionally comprise at least one element from the following group: distance from the longitudinal axis A, axial position in relation to the longitudinal axis A, angular position in relation to the longitudinal axis A, slope in relation to the longitudinal axis A.

In an optional step S6, the geometry to be supplied is determined in a manner dependent on a predefined fluid penetration, starting from the outer opening 19 of the respective injection hole 17, to the outside of the nozzle body 1. For example, values for diameters D1 and D2 and the length L of a conical injection hole 17 are determined in this way, making a contribution to the achievement of a desired fluid penetration.

This takes account of the fact that the fluid penetration from an injection hole 17 into a combustion chamber of an internal combustion engine is dependent inter alia on the geometry of the respective injection hole 17. In this way, fluid penetration may be adapted individually for each injection hole 17 within certain limits.

In a further step S7, a height H of a blind hole step 15 of a blind hole 13 to be formed is determined in a manner which is dependent on the predefined fluid penetration, starting from the outer opening 19 of the respective injection hole 17, to the outside of the nozzle body 1.

In this way, it is possible to control fluid penetration by determining and subsequently forming the blind hole step 15 with the height H and, inter alia, to make a contribution to combating soot formation on the nozzle body tip 20. A nozzle body 1 which has a blind hole contour determined in a manner dependent on a desired fluid penetration thus allows reliable operation of a fluid injection valve comprising the nozzle body 1 that is to be produced and contributes to a longer service life.

The formation of the blind hole step 15 of the determined height H affects the fluid penetration associated with all the injection holes 17 to be introduced since the blind hole step 15 is arranged ahead of the inner opening 18 of the respective injection hole 17 that is still to be introduced, in relation to a flow direction of a flowing fluid. In respect of a finished nozzle body 1, the respective injection hole 17 is then arranged after the blind hole step 15 in relation to the flow direction of a fluid. In other words, the at least one injection hole 17 provided is formed between one blind hole step end 16 of the blind hole step 15 and the nozzle body tip 20.

As an option, the height H of the blind hole step 15 is additionally determined in a manner dependent on the supplied and possibly determined geometry of the at least one injection hole 17 to be formed.

This takes into account the fact that fluid penetration is dependent on interaction between the length L and diameter of a cylindrical injection hole 17 and the height H of the blind hole step 15, for example. These parameters may be matched to one another in mutual dependence in such a way that a desired fluid penetration is achieved. In this way, it is possible, for example, to meet fluid penetration requirements that may be achieved only with difficulty by the formation of the blind hole step 15 alone. It is then useful, for example, to additionally determine a value for the height H of the blind hole step 15 in a manner dependent on the geometry of the injection hole 17 in order in this way to achieve the desired fluid penetration and allow a simple production process.

In a further step S9, a part of the shape of an inner surface of the wall 9 is adapted and the blind hole 13 with the blind hole step 15 of the determined height H in relation to the longitudinal axis A is thereby formed in a region of the second axial end 5 of the nozzle body blank.

In respect of advantageous symmetrical formation of the nozzle body 1 and of a device for a fluid injection valve, the blind hole step 15 is formed substantially parallel to the longitudinal axis A of the nozzle body 1. In another embodiment, however, it is also possible for the blind hole step 15 to have a slope relative to the longitudinal axis A and thereby to influence fluid penetration. In such a case, the height H of the blind hole step 15 then relates, for example, to a projection of the geometrical length thereof parallel to the longitudinal axis A.

Adaptation of a part of the shape of the inner surface of the wall 9 also includes forming a seat region 21 for a nozzle needle adjoining the blind hole step 15 in the direction of the first axial end 3 and thus remote from the nozzle body tip 20, for example. In a closed position, the seat region 21 prevents fluid flow in interaction with a sealing seat of the nozzle needle, and otherwise allows flow in an open position.

As an option, adaptation of a part of the shape of the inner surface of the wall 9 also includes forming a guiding region 23 for guiding the nozzle needle in the region of the first axial end 3 in the direction of the second axial end 5.

In a further step S11, the at least one injection hole 17 is introduced in a region of the blind hole 13 between the blind hole step end 16 facing the second axial end 5 and the nozzle body tip 20 with the supplied geometry data and, if appropriate, in a manner dependent on the predefined fluid penetration and/or the determined height H of the blind hole step 15. For example, the at least one injection hole 17 is introduced into the nozzle body blank by boring and/or turning and, in this way, the nozzle body 1 is formed.

In a step S13, the method for producing the nozzle body for a fluid injection valve is ended.

In a development, determination of the height H is carried out in a manner dependent on the predefined geometry data—e.g. in a manner dependent on the length L, the slope and the distance from the longitudinal axis—and on the shape of the nozzle body blank. In this case, the height H, in particular, is chosen in such a way that the blind hole step 15 reduces the wall thickness of the wall 9 to such an extent that the injection hole 17 introduced into the wall 9 in accordance with the supplied geometry data penetrates the wall downstream of the blind hole step 15 from the inner surface 10 thereof to the outer surface 11 of the nozzle body 1—in particular without a step.

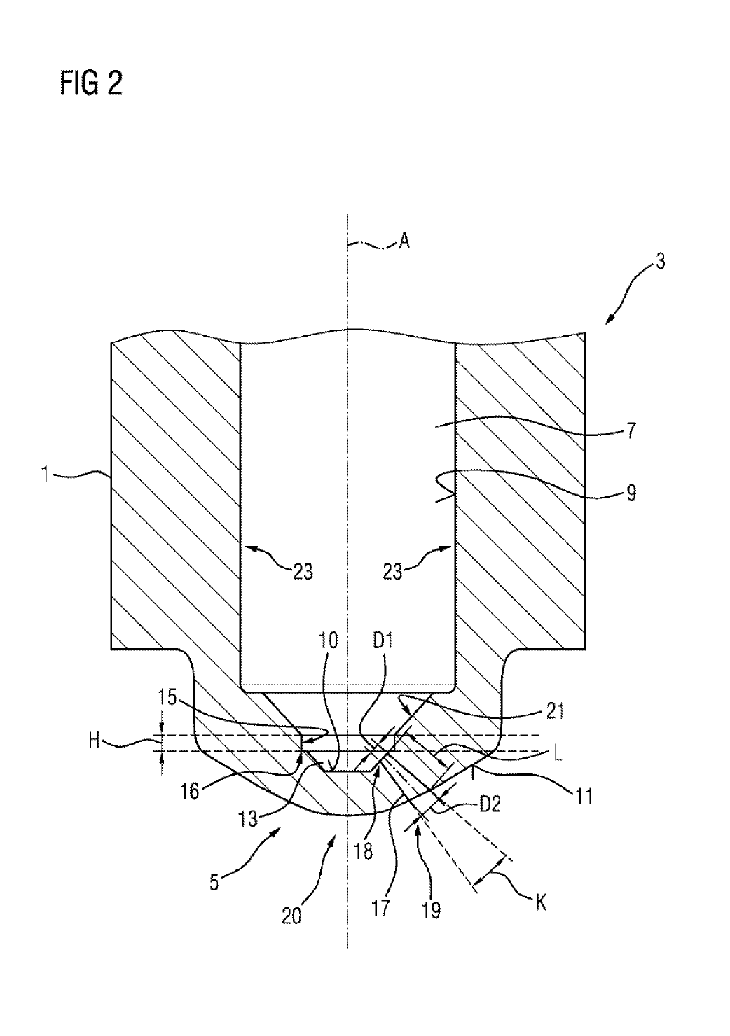

FIG. 2 shows a section through an illustrative embodiment of the nozzle body 1, which has been produced by means of the method described in FIG. 1, for example. The nozzle body 1 has the first axial end 3, the second axial end 5 and the longitudinal axis A and is of substantially rotationally symmetrical design.

The wall 9 forms the nozzle body recess 7 and includes the guiding region 23, the seat region 21 and a blind hole contour of the blind hole 13 with the blind hole step 15, which blind hole step is formed with the height H determined in a manner dependent on the predefined fluid penetration. The blind hole step 15 is formed coaxially with the longitudinal axis A in the shape of the lateral surface of a cylinder. In other embodiments, the blind hole step 15 may have a slope relative to the longitudinal axis A, with the result that the nozzle body 1 includes a frustoconical blind hole step 15.

In this illustrative embodiment, the nozzle body 1 has a conical injection hole 17 below the blind hole step 15, to be precise between the blind hole step end 16 and the nozzle body tip 20. The first diameter D1 is associated with the inner opening 18 and is of smaller design than the second diameter D2, which is associated with the outer opening 19 of the injection hole 17.

Accordingly, the injection hole 17 has a cone angle K, which may affect fluid penetration. The cone angle K is determined by the two diameters D1 and D2 and the length L of the injection hole 17 and is supplied as the geometry of the injection hole 17 in the context of the production of the nozzle body 1 and has optionally been determined in a manner dependent on a desired fluid penetration.

The nozzle body 1 makes possible a desired fluid penetration in a simple manner by means of the blind hole step 15 formed in a controlled manner and having the determined height H and thereby makes possible reliable operation of an associated fluid injection valve. It contributes to keeping down pollutant emissions in an internal combustion engine.

A number of implementations have been described. Nevertheless, it will be understood that various modifications may be made without departing from the spirit and scope of the disclosure. Accordingly, other implementations are within the scope of the following claims.

1. A method for producing a nozzle body for a fluid injection valve, comprising:
supplying a nozzle body blank, which has a longitudinal axis as well as a first axial end and a second axial end with a nozzle body tip in relation to the longitudinal axis,
introducing a nozzle body recess into the nozzle body blank, starting from the first axial end, and thereby forming a wall between the nozzle body recess and an outer surface of the nozzle body blank,
supplying geometry data of at least one injection hole to be provided, for penetrating the wall as far as the outer surface, starting from the nozzle body recess, with an inner opening, which faces the nozzle body recess, and an outer opening which faces the outer surface,
determining a height of a blind hole step of a blind hole to be formed, in a manner which is dependent on a predefined fluid penetration, starting from the outer opening of the respective injection hole, into the environment of the nozzle body,
adapting a part of the shape of an inner surface of the wall and thereby forming the blind hole with the blind hole step of the determined height in relation to the longitudinal axis in a region of the second axial end of the nozzle body blank, and
introducing the at least one injection hole into the wall with the supplied geometry data in a region of the blind hole between a blind hole step end facing the second axial end and the nozzle body tip in such a way that the at least one injection hole penetrates the wall.

2. The method as claimed in claim 1, wherein the injection hole is shaped in such a way that the injection hole penetrates the wall without a step from the inner surface to the outer surface.

3. The method as claimed in claim 1, wherein adapting a part of the shape of an inner surface of the wall and consequent formation of the blind hole with the blind hole step of the determined height is accomplished by reducing the wall thickness of a part of the wall between the nozzle body recess and the outer surface.

4. The method as claimed in claim 2, wherein
a length and a diameter are specified as geometry data of the at least one injection hole in order to achieve the predefined fluid penetration, and
the height of the blind hole step is chosen in such a way that the blind hole step reduces the wall thickness between the inner surface and the outer surface to such an extent that, when the injection hole with the determined length and the outer opening in the outer surface is introduced, the inner opening is positioned in the inner surface.

5. The method as claimed in claim 1, wherein
the supplied geometry data comprise a first diameter and a second diameter of the at least one injection hole, such that the injection hole to be introduced is conical, and
the first diameter and the second diameter are determined in a manner dependent on the predefined fluid penetration, wherein the first diameter is assigned to the inner opening and the second diameter is assigned to the outer opening.

6. The method as claimed claim 5, wherein the first diameter and the second diameter of the at least one injection hole are additionally determined in a manner dependent on the determined height.

7. The method as claimed in claim 1, wherein adapting a part of the shape of the inner surface of the wall comprises forming a seat region for a nozzle needle adjoining the blind hole step in a direction of the first axial end.

8. The method as claimed in claim 1, wherein adapting a part of the shape of the inner surface of the wall comprises forming a guiding region for guiding a nozzle needle in the region of the first axial end in a direction of the second axial end.

9. A fluid injection valve for a motor vehicle, comprising:
a nozzle body which is produced by a method recited in claim 1, and
a nozzle needle which is arranged at least partially in the nozzle body recess in such a way as to be axially movable in relation to the longitudinal axis and which is designed to prevent a fluid flow in interaction with a seat region in a closed position and otherwise to allow said flow.
